(19) United States
(12) Patent Application Publication
(10) Pub. No.: US 2026/0154960 A1
(43) Pub. Date: Jun. 4, 2026

(54) APPLYING REMOTE SENSING DATA FOR PRECISION YIELD MAPPING IN AGRICULTURAL FIELDS

(71) Applicant: SOUTH DAKOTA BOARD OF REGENTS, Pierre, SD (US)

(72) Inventors: Ali Mirzakhani Nafchi, Brookings, SD (US); Salman Mirzaee, Brookings, SD (US)

(21) Appl. No.: 19/406,166

(22) Filed: Dec. 2, 2025

Related U.S. Application Data
(60) Provisional application No. 63/727,098, filed on Dec. 2, 2024.

(51) Int. Cl. G06V 20/10; G01W 1/02; G06V 10/26; G06V 10/56; G06V 10/75; G06V 10/82; G06V 20/13

(52) U.S. Cl. CPC G06V 20/188; G01W 1/02; G06V 10/26; G06V 10/56; G06V 10/751; G06V 10/82; G06V 20/13

(57) ABSTRACT

Disclosed herein are systems and methods for creating virtual yield maps. A computing device collects one or more images from one or more satellites, the one or more images capturing at least a crop-containing plot, topography information for the crop-containing plot from one or more topographical sensors, and weather-related data for an area including the crop-containing plot. The computing device creates, based at least in part on information associated with the one or more images, a spectral index map. The computing device generates pixelized information for the crop-containing plot comprising a plurality of pixels representative of an equal portion of the crop-containing plot and includes a normalized value representative of crop yield for each respective pixel of the plurality of pixels based at least in part on the spectral index map, the topography information, and the weather-related data. The computing device creates a virtual yield map from the pixelized information.

### CROSS-REFERENCE TO RELATED APPLICATION(S)

This application claims the benefit under 35 U.S.C. § 119 (e) to U.S. Provisional Application 63/727,098, filed Dec. 2, 2024, and entitled “APPLYING REMOTE SENSING DATA FOR PRECISION YIELD MAPPING IN AGRICULTURAL FIELDS”, which is hereby incorporated herein by reference in its entirety.

### FIELD

The various examples herein relate to virtually representing crop yield.

### BACKGROUND

Traditionally, farmers have relied on observations to understand their field variations and categorize them to improve their operations and production. Today, decision-making tools and data sources, including yield monitoring systems, aerial imagery, soil test results, Electrical Conductivity (EC) mapping, topography, and NRCS soil survey maps, assist farmers in detecting their field variations. Static characteristics like soil data, EC, topography, and NRCS soil survey maps provide information on intrinsic factors that impact field capacity and yield potential. On the other hand, the impact of dynamic real-world factors such as weather patterns and environmental interactions can be observed in yield data and aerial images collected during the growing season, capturing all the factors influencing yield.

### BRIEF SUMMARY

Discussed herein are various examples for creating accurate and informative virtual yield maps. The system collects information from various sources, the information including satellite images, topography information, and weather-related data for areas that include a crop-containing plot of land. Based on this information, the system creates a spectral index map, from which pixelized information for the crop-containing play is generated. The pixelized information represents a normalized value representative of crop yield for each respective pixel of the plurality of pixels based at least in part on the spectral index map, the topography information, and the weather-related data. Using the pixelized information, the system creates a virtual yield map to show concentrations of crops using actual yield information known to the farmer. These virtual yield maps can be output in a graphical user interface such that a farmer can quickly ascertain which areas of their plots are the most heavily concentrated with crops and which factors led to the success of those areas of the plot as compared to other areas of the plots. Farmers may also use this information to guide which areas should be harvested first to get the most amount of crop in the shortest amount of time by focusing on the more concentrated areas first.

The techniques described herein provide a comparative advancement in identifying field variations for limited-resource farmers without yield monitoring systems. This approach is practical for creating management zones, especially for farmers with limited access (55% do not use the yield monitoring system) to technologies without yield monitoring systems. With the power of satellite imagery, the techniques described herein may gauge total harvested yield distribution into the whole field as a strategic method for creating management zones.

Satellite information is a transformative tool that identifies inconsistencies across fields, facilitating the creation of management zones to understand spatial yield variability better. Remote sensing and integrated satellite data help farmers develop informed strategies reflecting field conditions, leading to optimized agricultural outputs and better resource management. Satellite imagery identifies variabilities in agricultural fields, supporting the creation of management zones aligned with smart agricultural practices. This tool empowers farmers with the knowledge to manage and highlight field variations, ensuring optimal contributions from every part of the farm. Each zone, based on its unique conditions, may have specific farming requirements to maximize crop growth and yield.
In Example 1, a method comprises (a) collecting, by one or more processors, one or more images from one or more satellites, the one or more images capturing at least a crop-containing plot; (b) collecting, by the one or more processors, topography information for the crop-containing plot from one or more topographical sensors; (c) collecting, by the one or more processors, weather-related data for an area including the crop-containing plot; (d) creating, by the one or more processors and based at least in part on information associated with the one or more images, a spectral index map; (e) generating, by the one or more processors, pixelized information for the crop-containing plot, the pixelized information comprising a plurality of pixels representative of an equal portion of the crop-containing plot, and wherein the pixelized information further comprises a normalized value representative of crop yield for each respective pixel of the plurality of pixels based at least in part on the spectral index map, the topography information, and the weather-related data; and (f) creating, by the one or more processors, a virtual yield map from the pixelized information.
Example 2 relates to the method of Example 1, wherein collecting the one or more images from the one or more satellites comprises controlling, by the one or more processors, the one or more satellites to capture the one or more images.
Example 3 relates to the method of one or more of Examples 1-2, wherein collecting the topography information from the one or more topographical sensors comprises controlling, by the one or more processors, the one or more topographical sensors to capture the topography information.
Example 4 relates to the method of one or more of Examples 1-3, further comprising: (a) determining, by the one or more processors, one of a plurality of unique crop indices based on a type of crop grown in the crop-containing plot; (b) filtering, by the one or more processors, colors not associated with the type of crop grown in the crop-containing plot from the one or more images to create one or more filtered images; and (c) extracting, by the one or more processors, the information used to create the spectral index map from the one or more filtered images.
Example 5 relates to the method of Example 4, wherein the colors not associated with the type of crop include one or more of brown, red, or soil colors.
Example 6 relates to the method of any one or more of Examples 1-5, wherein the information associated with the one or more images comprises one or more of a normalized difference vegetation index (NDVI) or an excess green.
Example 7 relates to the method of any one or more of Examples 1-6, wherein each of the one or more images are captured at a different time, and wherein the method further comprises: (a) comparing, by the one or more processors, each of the one or more images to determine an optimal image based on peak values of the information associated with the one or more images; and (b) determining, by the one or more processors, the information associated with the optimal image to create the spectral index map.
Example 8 relates to the method of Example 7, further comprising: (a) utilizing, by the one or more processors, the topography information and the weather-related data that includes the time at which the optimal image was captured.
Example 9 relates to the method of any one or more of Examples 1-8, wherein the topography information comprises any one or more of: (i) one or more satellite images, (ii) one or more LiDAR images, (iii) GPS information, and (iv) a map generated from the GPS information.
Example 10 relates to the method of any one or more of Examples 1-9, wherein the weather-related data comprises any one or more of: (i) average temperature information, (ii) high temperature information, (iii) low temperature information, (iv) growing degree days, (v) moisture information, (vi) precipitation information, (vii) amount of sunshine, and (viii) intensity of light.
Example 11 relates to the method of any one or more of Examples 1-10, wherein the spectral index map comprises a distributed classification of a normalized number representing a normal distribution of a yield of crop in the crop-containing plot.
Example 12 relates to the method of any one or more of Examples 1-11, wherein generating the pixelized information further comprises: (a) calculating, by the one or more processors, an acreage proportion for each of the plurality of pixels based at least in part on the spectral index map, the topography information, and the weather-related data.
Example 13 relates to the method of any one or more of Examples 1-12, wherein creating the virtual yield map further comprises: (a) applying, by the one or more processors, the pixelized information to a known actual yield to generate the virtual yield map comprising a representation of an actual amount of crops in the particular area represented by each respective pixel of the plurality of pixels.
Example 14 relates to the method of any one or more of Examples 1-13, further comprising: (a) outputting, by the one or more processors and to a display component, the virtual yield map in a graphical user interface.
Example 15 relates to the method of any one or more of Examples 1-14, wherein the one or more images comprise multi-date aerial or satellite imagery captured across a growing season, and wherein the method further comprises: (a) processing, by the one or more processors, the multi-date imagery as a time series using a recurrent neural network comprising a long short-term memory (LSTM) architecture to estimate standardized phenological stages and to select an optimal image window during an early reproductive stage based on peak or stable values of the information associated with the multi-date imagery; and (b) handling, by the one or more processors, missing imagery dates caused by cloud cover by one or more of interpolation across time steps, explicit masking of missing dates, or using models configured to cope with irregular temporal sampling.
Example 16 relates to the method of any one or more of Examples 1-15, further comprising: (a) performing, by the one or more processors, semantic segmentation of the one or more images to classify pixels into classes comprising crop, weed, bare soil, and residue using a convolutional neural network with an encoder-decoder architecture trained on manually labeled data; and (b) masking, by the one or more processors, clouds, cloud shadows, haze, roads, buildings, and water bodies using automated algorithms comprising thresholding and machine learning classifiers and optionally manual inspection, prior to creating the spectral index map.
Example 17 relates to the method of any one or more of Examples 1-16, further comprising: (a) generating, by the one or more processors, a timing-based zone map by partitioning timing deviation vectors using one or more of threshold-based classification, k-means clustering, Gaussian mixture models, or hierarchical clustering to identify zones comprising early, catch-up, and delayed maturity trajectories; and (b) applying, by the one or more processors, the timing-based zone map as a correction weighting layer to adjust the spectral index map and the pixelized information before creating the virtual yield map.
Example 18 relates to the method of any one or more of Examples 1-17, wherein the information associated with the one or more images comprises one or more vegetation or canopy indices selected from the group consisting of green normalized difference vegetation index (GNDVI), normalized difference red-edge index (NDRE), red-edge position (REIP), enhanced vegetation index (EVI), soil-adjusted vegetation index (SAVI), modified soil-adjusted vegetation index (MSAVI or MSAVI2), normalized difference water index (NDWI), normalized difference moisture index (NDMI), multi-band drought indices, thermal-based metrics, and canopy height or surface models, wherein the one or more images comprise spectral bands including blue, green, red, near-infrared, red-edge, and shortwave infrared, and wherein the topography information further comprises elevation, slope, aspect, and compound terrain indices including a topographic wetness index, and the weather-related data further comprises solar radiation, humidity, wind, evapotranspiration, and soil water storage.
Example 19 relates to the method of any one or more of Examples 1-18, further comprising: (a) segmenting, by the one or more processors, the crop-containing plot into analysis units comprising one or more of regular grid cells, management zones, or polygons defined by soil or electrical conductivity classes; (b) deriving, by the one or more processors, and for each acquisition time, a feature vector for each analysis unit; and (c) appending, by the one or more processors, and to each feature vector, time-varying environmental variables comprising daily temperature, cumulative growing degree days, and rainfall over recent windows, static covariates comprising soil properties, topography, and long-term management indicators, and ancillary datasets comprising one or more of planting date, seeding rate, row spacing and orientation, type and timing of tillage, fertilizer and manure applications including type, rate, timing, and placement, irrigation events, cover crop species and termination, traffic patterns, and crop protection measures.
In Example 20, a method comprises performing any of the techniques of any combination of Examples 1-19.
In Example 21, a device is configured to perform any of the methods of any combination of Examples 1-19.
In Example 22, an apparatus comprises means for performing any of the method of any combination of Examples 1-19.
In Example 23, a non-transitory computer-readable storage medium has stored thereon instructions that, when executed, cause one or more processors of a computing device to perform the method of any combination of Examples 1-19.
In Example 24, a system comprises one or more computing devices configured to perform a method of any combination of Examples 1-19.
In Example 25, any of the techniques described herein are included.

While multiple examples are disclosed, still other examples will become apparent to those skilled in the art from the following detailed description, which shows and describes illustrative examples. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a conceptual diagram illustrating a computer device that gathers information to create a spectral index map and, using known yield, can generate estimated yield maps of the crop, in accordance with one or more techniques described herein.

FIG. 2 is a block diagram illustrating a more detailed example of a computing device configured to perform the techniques described herein.

FIG. 3 includes representations of studied fields on the southern parts of South Dakota State, field 1-7 (a), field 8-13 (b), field 14-16 (c), and field 17-19 (d), in accordance with one or more techniques described herein.

FIG. 4 is a number of charts for determining the best window of employing NDVI data to distribute yield map based on different soil types, in accordance with one or more techniques described herein.

FIG. 5 are maps illustrating NDVI, distributed, and actual corn yield maps for a sample field, in accordance with one or more techniques described herein.

FIG. 6 are maps illustrating NDVI, distributed, and actual soybean yield maps for a sample field, in accordance with one or more techniques described herein.

FIG. 7 is a pair of charts illustrating results of evaluating developed methodology; r (correlation coefficient) for corn (a) and soybean (b) fields, in accordance with one or more techniques described herein.

FIG. 8 is a flow diagram illustrating an example method for calculating a virtual yield map, in accordance with one or more techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

The techniques described herein center on generating accurate, high-resolution virtual yield maps for agricultural fields by integrating multi-date remote sensing imagery, environmental and terrain data, and ancillary management records, without requiring an onboard yield monitor. A computing device acquires aerial or satellite imagery across the growing season, performs semantic segmentation and artifact masking to isolate crop signals, and computes a suite of vegetation and canopy indices across spectral bands including red-edge and shortwave infrared. Time-series models, such as recurrent neural networks with long short-term memory architectures, estimate standardized phenological stages and derive timing deviation vectors that characterize differences in development speed and maturity trajectories across the field.

These timing deviations are partitioned by thresholding and unsupervised clustering into timing-based crop performance zones (e.g., early, catch-up, delayed maturity). The resulting zone map is normalized and applied as a correction weighting layer to adjust the spectral index map and the pixelized yield distribution, compensating for asynchronous canopy development that single-date indices alone cannot capture. The system further augments feature vectors with topography (elevation, slope, aspect, topographic wetness index), weather forcing (temperature, growing degree days, precipitation, solar radiation, humidity, wind, evapotranspiration, soil water storage), soil properties, and management operations (planting, seeding rate, row geometry, tillage, fertilizer and manure timing and placement, irrigation, cover crops, traffic patterns, crop protection). Missing imagery dates due to cloud cover are handled via interpolation, explicit masking, or models robust to irregular temporal sampling.

Using a known total harvested yield for the field, the device distributes yield across equal-area pixels according to correction-weighted productivity scores derived from the spectral index map, timing-based zones, terrain, and weather covariates, thereby creating a virtual yield map that reflects spatial yield variability at fine resolution. The concept delivers a practical solution for limited-resource farmers lacking yield monitors, enabling creation of management zones and data-driven prescriptions, while securing agronomic data through encryption in transit and at rest. This combination of time-series phenology estimation, timing-based zone weighting, multi-spectral index computation, robust masking and segmentation, and integrated environmental and management context distinguishes the approach from prior methods reliant on single-date NDVI or purely static datasets.

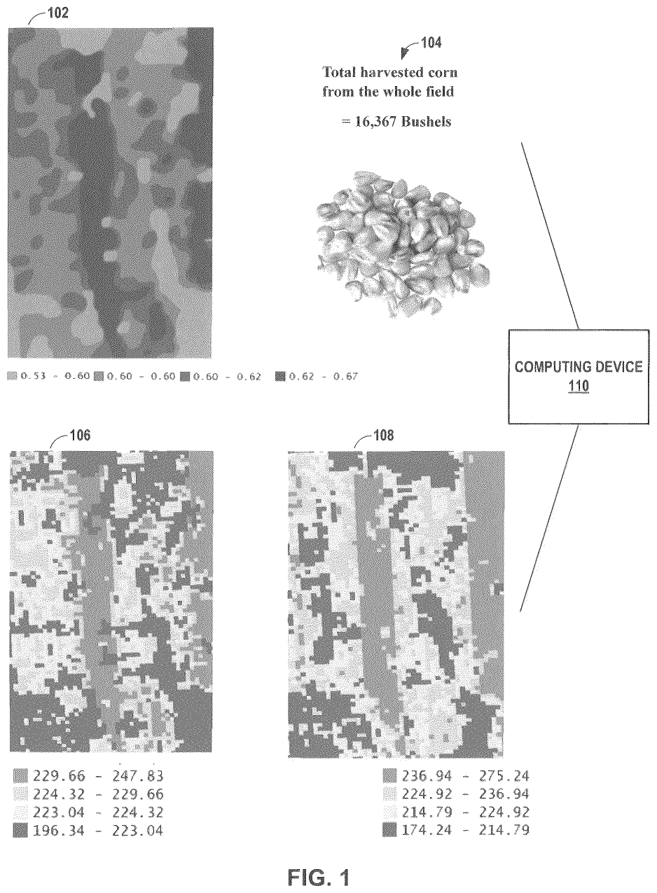

FIG. 1 is a conceptual diagram illustrating a computer device that gathers information to create a spectral index map and, using known yield, can generate estimated yield maps of the crop, in accordance with one or more techniques described herein.

Spectral index map 102 may be representative of numbers indicating a normal distribution of known yield 104. From this information, as well as topography information and weather-related data, computing device 110 may generate virtual yield map 106, where different colors of the pixels in virtual yield map 106 indicate different concentrations of the known amount of crop based on the information available to computing device 110. This can be compared to actual distribution map 108.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

Agricultural yield estimation and field management have traditionally relied on manual observations and static data sources, such as soil test results, electrical conductivity (EC) mapping, topography, and NRCS soil survey maps. While these methods provide insights into field characteristics, they fail to account for dynamic factors such as weather patterns, crop phenology, and environmental interactions that significantly influence yield variability. Yield monitoring systems, which offer real-time data during harvest, are effective but remain inaccessible to many farmers due to cost and equipment limitations, with approximately 55% of farmers lacking access to such systems. Furthermore, conventional remote sensing techniques, such as vegetation indices like NDVI, provide information on plant health but are insufficient for accurately predicting yield due to their inability to integrate multiple agronomic variables, such as soil properties, weather data, and management practices.

The present system and method address these limitations by introducing a framework for creating virtual yield maps (VYMs) that utilize satellite imagery, topography information, weather-related data, and advanced machine learning techniques. Unlike conventional approaches, the described system integrates multi-source data to generate pixelized information for crop-containing plots, where each pixel represents a normalized yield value based on spectral index maps, topography, and weather data. This pixelized information is then used to create virtual yield maps that represent spatial yield variability across the field with improved accuracy. By employing specialized algorithms, such as time-series models (e.g., LSTMs) for phenological stage estimation and clustering techniques for timing-based zone mapping, the framework enhances the selection of satellite imagery and accounts for missing data caused by cloud cover. Additionally, semantic segmentation models classify pixels into categories such as crop, weed, and bare soil, ensuring precise data extraction and minimizing noise from non-agricultural features.

The described concept significantly improves upon prior methods by enabling farmers to identify field variations and create management zones without requiring yield monitoring systems. The system provides high-resolution yield maps (e.g., 50 square feet per pixel) using only satellite imagery and total harvested yield data, which are widely accessible to farmers. This approach empowers farmers to make informed decisions regarding resource allocation, harvest prioritization, and agronomic interventions, enhancing productivity and sustainability. By integrating dynamic environmental factors, historical management data, and advanced computational techniques, the described system offers a practical, cost-effective solution for precision agriculture, addressing the needs of farmers with limited technological resources.

In accordance with the techniques of this disclosure, computing device 110 collects one or more images from one or more satellites, the one or more images capturing at least a crop-containing plot. Computing device 110 collects topography information for the crop-containing plot from one or more topographical sensors. Computing device 110 collects weather-related data for an area including the crop-containing plot. Computing device 110 creates, based at least in part on information associated with the one or more images, a spectral index map 102. Computing device 110 generates pixelized information for the crop-containing plot, the pixelized information comprising a plurality of pixels representative of an equal portion of the crop-containing plot, and wherein the pixelized information further comprises a normalized value representative of crop yield for each respective pixel of the plurality of pixels based at least in part on the spectral index map, the topography information, and the weather-related data. Computing device 110 creates a virtual yield map 106 from the pixelized information.

Traditionally, farmers have relied on observations to understand their field variations and categorize them to improve their operations and production. Today, decision-making tools and data sources, including yield monitoring systems, aerial imagery, soil test results, Electrical Conductivity (EC) mapping, topography, and NRCS soil survey maps, assist farmers in detecting their field variations. Static characteristics like soil data, EC, topography, and NRCS soil survey maps provide information on intrinsic factors that impact field capacity and yield potential. On the other hand, the impact of dynamic real-world factors such as weather patterns and environmental interactions can be observed in yield data and aerial images collected during the growing season, capturing all the factors influencing yield.

Crop yield estimation is a widely researched topic that incorporates field surveys, meteorological data, environmental conditions, and modeling methods using remote sensing to predict and estimate yield. Various machine learning algorithms throughout the growing season integrate remote sensing data into crop models, which can enhance the accuracy of crop yield estimations and improve dynamic simulations. Recent progress in crop yield estimation using image-processing technologies is promising with high accuracy, low cost, and non-destructive calculation. It examines different schemes and algorithms used for yield calculation. The extensive research underscores the role of accurate yield predictions in enhancing agricultural productivity and optimizing resource use.

Remote sensing crop yield estimation and yield monitoring maps are both methods used to assess crop yields, but they differ in their approaches, technologies, and applications. Satellite imagery, aerial photography, and drone-based imaging are data sources for remote sensing crop yield estimation that can provide data at regular intervals, depending on the satellite's orbit or drone flight schedule, allowing for frequent monitoring over a growing season. It performs monitoring vast agricultural areas, making it suitable for regional, national, or even global crop yield assessments and does not require physical presence in the field, reducing labor and time costs with advantage of access to historical imagery for trend analysis and long-term monitoring. Yield monitoring maps may be generated from on-the-ground sensors and equipment mounted on harvesting machinery collecting real-time data during the harvest process, providing highly localized information.

Yield is influenced by a complex interplay of multiple factors, many of which may not be reflected in vegetation indices (e.g. NDVI) readings alone. While vegetation indices are useful tools for monitoring plant health and growth stages, they are not the sole determinant of yield estimation.

Variations in temperature, rainfall, sunlight, soil health, fertility, crop rotation, erosion, differences in fertilizers, planting densities, and irrigation methods, and levels of pests and diseases can influence yield independently of vegetation indices (e.g. NDVI). Crop yield estimation is heavily reliant on the accurate collection of data, accuracy of the models and techniques, and the integration of various agronomic variables. Inaccurate data inputs, unpredictable weather conditions, and pest infestations are the factors that contribute to significant discrepancies in yield predictions which are not accounted for. Converting the Vegetation Indices and making accurate VYMs may be practical for farmers with limited access to technologies and without yield monitoring systems that provides detailed and accurate yield data at the field level, allowing for precise yield virtual mapping. The methods and techniques described herein use satellite imagery and total harvested yield (all farmers have this number) to identify field variations during growing season and before harvest to provide high-resolution (50 sqft) accurately and give virtual yield maps.

Collected data can be integrated with other farm management systems for comprehensive and detailed yield analysis within the fields, identifying high and low-yielding areas, that support site-specific management practices and help in evaluating the effectiveness of agricultural practices and inputs used during the growing season.

In FIG. 1, the Sentinel-2 satellite was used to create a vegetation index. Computing device 110 may create and process vegetation indices. Finally, computing device 110 may generate an estimated yield map 106.

To begin, computing device 110 may collect information from the APIs (including Vegetation Indices, Topography, and Temperature.

Computing device 110 may choose and create the best Normalized Difference Vegetation Indices (for example but not necessarily NDVI) map and process the data.

Computing device 110 may distribute the total yield (total bushels) across the field using the NDVI map. In order to perform this step, computing device 110 may determine the proportion of each zone based on NDVI. To calculate the acreage proportions of each zone using, for example, GIS software (for example: Zone 1, Zone 2, Zone 3, and Zone 4), computing device 110 may assign normalized (NDVI) values with relative productivity based on the NDVI values for each zone (NDVI1, NDVI2, NDVI3, and NDVI4). To calculate the weighted NDVI, computing device 110 may multiply the NDVI values by the acreage of each zone to find the weighted NDVI contribution:

$$Total Weighted NDVI = ( NDVI 1 \times Z 1 ) + NDVI 2 \times Z 2 ) + ( NBVI 3 \times Z 3 ) + ( NDVI 4 \times Z 4 )$$

Computing device 110 may use the total weighted NDVI to determine the proportion of the total yield each zone should receive:

$$Yield of each zone = ( NBVI of Zone \times Acreage of Zone / Total Weighted NDVI ) \times Total Yield )$$

Computing device 110 may then calculate the yield for each zone:

$$Yield of Z 1 = ( NDVI 1 \times Z 1 / Total Weighted NDVI ) \times Total Yield$$

$$Yield of Z 2 = ( NDVI 2 \times Z 2 / Total Weighted NDVI ) \times Total Yield$$

$$Yield of Z 3 = ( NBVI 3 \times Z 3 / Total Weighted NDVI ) \times Total Yield$$

$$Yield of Z 5 = ( NDVI 4 \times Z 4 / Total Weighted NDVI ) \times Total Yield$$

$$Sum = Total Yield$$

By providing the NDVI values for each zone and plug them into the equations, computing device 110 may find the accurate yield distribution for each zone.

FIG. 1 shows a yield mapping system that utilizes a computing device 110 to process agricultural data and generate maps representing crop yield distribution across a field. The system integrates multiple data sources and computational techniques to create a virtual yield map 106 and compare the virtual yield map 106 to an actual distribution map 108.

The spectral index map 102 is an integral part of the system, representing normalized vegetation indices derived from satellite imagery. This map provides a distributed classification of vegetation health and density across the crop-containing plot. The spectral index map 102 serves as a primary input for the yield mapping process, enabling the computing device 110 to analyze spatial variations in crop performance.

The total harvested corn 104 represents the actual yield collected from the entire field, quantified as 16,367 bushels. This data is used by the computing device 110 to calibrate and validate the virtual yield map 106. By distributing the total yield across the field based on the spectral index map 102, the system ensures that the virtual yield map 106 accurately reflects the spatial yield variability.

The virtual yield map 106 is generated by the computing device 110 using pixelized information derived from the spectral index map 102, topography data, and weather-related data. Each pixel in the virtual yield map 106 corresponds to an equal portion of the crop-containing plot and is assigned a normalized value representing the estimated yield for that specific area. The map visually displays yield concentrations, with different colors indicating varying levels of productivity.

The actual distribution map 108 provides a representation of the real-world yield distribution across the field. This map serves as a benchmark to assess the accuracy of the virtual yield map 106. By comparing the virtual yield map 106 to the actual distribution map 108, the system can detect discrepancies and enhance computational models to achieve better yield estimation.

The computing device 110 orchestrates the entire process, collecting data from external sources, performing analyses, and generating the maps. The computing device 110 integrates information from the spectral index map 102, total harvested corn 104, and other environmental and agronomic datasets to produce actionable insights for precision agriculture.

In some examples, computing device 110 of FIG. 1 is configured to acquire multi-date aerial or satellite imagery across a growing season and to process the imagery as a time series to characterize crop developmental dynamics in the field represented by spectral index map 102. The imagery may include spectral bands such as blue, green, red, near-infrared, red-edge, and shortwave infrared, enabling the derivation of vegetation and canopy indices beyond normalized difference vegetation index. For instance, the device may compute indices comprising green NDVI, normalized difference red-edge index, red-edge position metrics, enhanced vegetation index, soil-adjusted vegetation index, modified soil-adjusted vegetation index, normalized difference water or moisture indices, multi-band drought metrics, thermal-based measures, and canopy height or surface models. By integrating these indices over time, computing device 110 may estimate standardized phenological stages for crops, such as VE-VT-R stages for maize, V/R stages for soybean, or BBCH stages for other crops, and may automatically select an optimal image or image window corresponding to early reproductive conditions that exhibit peak or stable canopy signals for generation of spectral index map 102.

To improve discrimination of crop signals from confounding features, computing device 110 may perform semantic segmentation of the multi-date imagery to classify pixels into agronomically relevant classes, such as crop, weed, bare soil, and residue. In one example, the semantic segmentation is implemented using a convolutional neural network with an encoder-decoder architecture trained on manually labeled data, optionally augmented with recurrent layers to capture temporal dependencies across the growing season. The resulting class masks may be applied to the imagery to remove contributions from weeds and non-crop vegetation that can distort canopy indices, thereby improving fidelity of spectral index map 102 and downstream pixelized information used to form virtual yield map 106.

In some implementations, computing device 110 executes cloud, shadow, and artifact masking prior to index computation. Automated algorithms may detect and mask clouds, cloud shadows, haze, and non-agricultural features such as roads, buildings, and water bodies, using a combination of thresholding, spectral tests, machine learning classifiers, and optionally manual inspection. When imagery dates are missing due to cloud cover or acquisition gaps, the device may handle the irregular temporal sampling by interpolating across time steps, explicitly masking missing dates during model training or inference, or using time-series models configured to operate with uneven intervals. These procedures maintain continuity of the time series used to select optimal imagery for spectral index map 102 and to generate the inputs that eventually form virtual yield map 106.

Computing device 110 may segment the crop-containing plot into analysis units to support scalable feature extraction and modeling. The analysis units may be regular grid cells, management zones, or polygons defined by soil or electrical conductivity classes. For each acquisition time, the device may derive a feature vector for each analysis unit that aggregates spectral indices, segmentation statistics, and quality flags. The device may append time-varying environmental variables to each feature vector, including daily temperature, cumulative growing degree days, rainfall over recent windows, and other weather-forcing inputs such as solar radiation, humidity, wind, evapotranspiration, and soil water storage. Static covariates may also be attached, including soil properties, topography, and long-term management indicators such as cover crop or manure history and tillage regime.

Topography information used by computing device 110 may extend beyond simple elevation to include slope, aspect, and compound terrain indices such as a topographic wetness index, derived from one or more of satellite-based elevation models, LiDAR sources, GPS tracks, or maps generated from GPS information. These terrain descriptors characterize cold air drainage, water accumulation, and drainage patterns that affect timing of emergence, vegetative vigor, and maturity. By integrating terrain predictors into the feature vectors associated with spectral index map 102, the device may improve estimates of spatial variability that lead to pixelized yield distributions represented in virtual yield map 106.

Ancillary datasets may be incorporated to contextualize the time-series imagery and environmental drivers. Computing device 110 may receive or ingest planting date, seeding rate, row spacing and orientation, type and timing of tillage, fertilizer and manure applications including type, rate, timing, and placement, irrigation events, cover crop species and termination, traffic patterns, and crop protection measures indicative of pest and disease management. The device may align these records to field coordinates and time stamps used for the imagery to explain deviations between the virtual yield map 106 and the actual distribution map 108, and to adjust model outputs where management interventions cause timing shifts in canopy development.

Using the assembled feature vectors across analysis units, computing device 110 may generate timing-based crop performance zones that reflect differences in development speed and phenological trajectories rather than solely canopy magnitude. In one example, the device computes timing deviation vectors that quantify departures from field-wide median or reference timing at key developmental transitions inferred from the time-series indices. The device may then partition the timing deviation vectors using threshold-based classification or unsupervised clustering methods, such as k-means, Gaussian mixture models, or hierarchical clustering, to identify zones that are consistently early across stages, zones that are late in emergence but catch up at subsequent stages, and zones that exhibit normal emergence but delayed maturity with longer green duration. A timing-based zone map is produced that assigns each analysis unit or pixel to a cluster.

The timing-based zone map may be normalized and used as a correction weighting layer applied to spectral index map 102 and the pixelized information that feeds virtual yield map 106. In one approach, computing device 110 computes weights for each zone proportional to observed or predicted timing deviations and applies these weights to adjust index-derived productivity scores prior to distributing total harvested corn 104 across the field. This correction layer accounts for asynchronous development trajectories that otherwise cause misallocation of yield when using single-date canopy snapshots. The adjusted pixelized information is then used by the device to produce virtual yield map 106 that more closely tracks actual distribution map 108.

In certain examples, computing device 110 employs recurrent neural networks, including long short-term memory architectures, to capture long-range temporal dependencies in canopy indices and environmental drivers. The models may learn relationships between accumulated thermal time, moisture-stress episodes, or management events and subsequent yield contributions for each analysis unit. By training on fields with known actual distribution maps 108, the device may calibrate model parameters and infer corrections applicable to fields where only total harvested corn 104 is available, yielding a robust method to generate virtual yield map 106 without an onboard yield monitor.

To safeguard sensitive agronomic data, computing device 110 may encrypt image inputs, topography information, weather-related data, ancillary datasets, intermediate feature vectors, and outputs including spectral index map 102 and virtual yield map 106. Encryption may be applied at rest within local or remote data stores and in transit across communication channels used to fetch weather feeds or to deliver maps to a graphical user interface. Authentication and authorization measures may restrict access to field-level datasets, thereby enhancing cybersecurity while enabling stakeholders to utilize the outputs for precision management.

In operation, computing device 110 may orchestrate the entire pipeline shown conceptually in FIG. 1. The device collects multi-date imagery, performs semantic segmentation and artifact masking, computes a suite of indices to form spectral index map 102, derives feature vectors augmented with environmental and terrain covariates, estimates phenological stages and timing deviations, generates a timing-based zone map, applies the correction weighting layer, and distributes total harvested corn 104 across the field to produce virtual yield map 106. The device may then compare virtual yield map 106 with actual distribution map 108 when available to quantify agreement, identify persistent discrepancies attributable to unmodeled stresses or management variations, and update model parameters to improve subsequent mapping cycles.

In some instances, computing device 110 may execute the various techniques described herein as a standalone software product. In other instances, the platform that provides the functionality for the techniques described herein may belong to a suite of software products, may be incorporated wholly into a separate software product and accessed within that separate software product, or may be called upon by a separate software product without user-facing access.

While FIG. 1 illustrates corn as an example of total harvested crop, the techniques described herein are applicable to a variety of crops whose canopy properties and phenology can be observed in multi-spectral time-series imagery. The selection of indices, phenological scales, clustering thresholds, and correction weights may be tailored per crop and per region, and the computing device 110 may dynamically adapt these parameters based on ancillary datasets and historical performance, thereby enabling a generalizable yield mapping framework that generates accurate virtual yield maps 106 across diverse agronomic contexts.

In one example implementation, a grower in Aurora County, South Dakota deploys the system represented in FIG. 1 to generate an operational virtual yield map for a 120-hectare field planted to maize. Prior to planting, the grower registers the field boundary with computing device 110 and authorizes connections to external data feeds for satellite imagery, local weather stations, and a farm management platform storing historical soil tests, electrical conductivity transects, and records of tillage and fertilizer applications. The field boundary is stored as a geospatial polygon used by computing device 110 to clip imagery and align ancillary datasets.

During the growing season, computing device 110 automatically acquires cloud-free Sentinel-2 and commercial aerial imagery whenever available, targeting Level-2 surface reflectance products that include blue, green, red, near-infrared, red-edge, and shortwave infrared spectral bands. For each acquisition date, the device performs geometric and radiometric checks and applies cloud, cloud-shadow, and haze masking using threshold tests and machine-learned classifiers. A semantic segmentation network, trained on labeled regional data, assigns pixels to crop, weed, bare soil, and residue classes, suppressing non-crop vegetation signals to improve canopy index fidelity. The device computes vegetation and canopy indices, including NDVI, GNDVI, NDRE, REIP, EVI, SAVI, MSAVI2, NDWI, and NDMI, and derives a canopy surface model where stereo pairs are available.

Concurrently, the device ingests daily weather data from a nearby mesonet station and a farm-level sensor network, calculating growing degree days, evapotranspiration, and soil water storage estimates from a water balance model. Topography layers are assembled from countywide LiDAR and satellite elevation models to derive elevation, slope, aspect, and a topographic wetness index indicative of water accumulation and cold air drainage. Static covariates including soil texture, organic matter, pH, cation exchange capacity, and electrical conductivity classes are imported from the grower's records. Management logs are synchronized, capturing planting date, hybrid maturity ratings, seeding rate and row spacing, pre-plant tillage, starter fertilizer type and rate, side-dress nitrogen timing and placement, herbicide applications, and irrigation events for the few pivot corners in the field.

Computing device 110 partitions the field into 50-square-foot grid cells as analysis units and, for each acquisition, compiles a feature vector per unit comprising masked spectral indices, quality flags, and segmentation summaries. Time-varying environmental variables are appended, including daily temperature, cumulative growing degree days, solar radiation, relative humidity, wind speed, precipitation totals over recent windows, and modeled evapotranspiration. Static terrain and soil covariates and long-term management indicators are attached. Where imagery dates are missing due to cloud cover, the device applies temporal interpolation and feeds irregular sequences into a recurrent neural network with long short-term memory layers trained to predict standardized phenological stages for maize (VE through VT and reproductive R stages) and to estimate timing deviation vectors relative to field-median trajectories.

Around the early reproductive phase, the device identifies an optimal image window characterized by peak and stable NDRE and EVI values that correlate strongly with eventual yield in local calibration datasets. Spectral index map 102 is produced from the optimal window, representing a distributed classification of normalized canopy productivity across the field. Timing deviation vectors from the LSTM model are clustered using Gaussian mixture modeling to generate a timing-based zone map that distinguishes consistently early areas on ridges, late-emergence low-lying zones that catch up after improved drainage, and zones with normal emergence but delayed maturity associated with higher water-holding capacity. The timing-based zone map is normalized and converted into a correction weighting layer that adjusts the spectral index map 102 and subsequent pixelized information to account for asynchronous development.

After harvest, the grower reports the total harvested corn 104 for the field based on elevator tickets and bin measurements, but the combine is not equipped with a yield monitor. Computing device 110 encrypts and stores the reported total yield and applies the correction-weighted pixelized information to distribute the total harvested bushels across the grid cells. For each cell, the device computes an acreage-weighted productivity score derived from the spectral index map 102, the topography and soil covariates, the weather forcing during the optimal window, and the timing-based correction, and scales the scores so that the sum equals the reported total yield. The resulting virtual yield map 106 is rendered in the grower's dashboard with color ramps indicating low to high bushels per acre, and tooltips display contributing factors for each cell, including canopy indices, terrain influences, and management events.

The grower validates the virtual yield map 106 by spot-checking high and low areas using handheld grain cart scales during a subsequent harvest of adjacent sections. Agreement between spot measurements and the virtual yield map 106 is within acceptable tolerances for zone delineation. Using the output, the grower defines three management zones for the following season. The consistently early, high-yield ridge zones receive a reduced nitrogen rate and variable seeding adjustments to curb lodging risk. The catch-up zones in lower positions are slated for targeted drainage maintenance and a modest increase in starter fertilizer to improve emergence. The delayed-maturity zones with longer green duration are assigned a fungicide timing aligned with the phenological predictions. The system archives the maps and inputs with encryption at rest and in transit, and, at season end, retrains the LSTM and clustering parameters using newly available sections where the grower installed a temporary yield monitor, thereby improving calibration. Over successive seasons, the grower leverages virtual yield maps 106 to optimize inputs, and the farm's average return on investment improves due to more precise zone prescriptions derived from the integrated remote sensing, environmental, and management data processed by computing device 110.

The techniques described herein constitute a practical application of computer technology to a specific, real-world agricultural use case rather than an abstract idea performed on a generic computer. The system integrates particular sensors and data sources, including multi-spectral satellite or aerial imagers, topographical sensors such as LiDAR and GPS, and time-resolved weather feeds, to acquire physically grounded measurements of a crop-containing plot. These measurements are processed by specifically configured modules that perform semantic segmentation, cloud and artifact masking, red-edge and shortwave infrared index computation, and time-series modeling using recurrent neural networks to estimate standardized phenological stages and timing deviations. The processing pipeline improves the functioning of the computer by enabling it to handle irregular temporal sampling, to select an optimal image window during an early reproductive stage, and to weight pixel outputs by a timing-based zone map that corrects asynchronous development trajectories. The end result is a virtual yield map used to allocate known total harvested yield across equal-area pixels and to guide concrete agronomic actions such as harvest scheduling, drainage maintenance, variable-rate input prescriptions, and zone creation.

The described techniques are tied to particular machines and manufactures. The computing device is expressly configured with communication and analysis modules to interact with external imagers and sensors, apply specialized image and signal processing algorithms, and output a graphical map representation. The operations do not simply manipulate data in the abstract, but rather transform raw sensor measurements into a spectral index map, generate pixelized information weighted by topography, weather forcing, and timing-based zones, and produce a virtual yield map that changes how a field is managed. This constitutes a transformation of data representative of a physical article into a different state or thing, yielding an actionable map that is more than a mere display of information.

The techniques provide a specific improvement in computer-implemented remote sensing and agricultural analytics. Conventional approaches relying on single-date NDVI or static soil maps cannot account for missing imagery, irregular sampling, or asynchronous phenology. By introducing semantic segmentation to remove weed signals, robust masking of clouds and artifacts, LSTM-based time-series phenology estimation, and clustering to generate timing-based correction weights, the disclosed system improves the accuracy and reliability of yield distribution without requiring a yield monitor. These improvements are rooted in technological solutions that enhance data acquisition, processing robustness, and model inference on computing hardware, rather than relying on generic instructions or mental steps.

The subject matter also does not risk undue preemption. The solution is confined to a particular implementation that utilizes defined spectral bands, enumerated vegetation and canopy indices, specified environmental and terrain covariates, and concrete modeling choices for segmentation, masking, time-series analysis, and clustering. Other ways of estimating yield using different sensors, indices, or modeling pipelines remain available. The recited encryption of agronomic data at rest and in transit further reflects practical computer operations addressing a technological problem in data privacy and cybersecurity in precision agriculture.

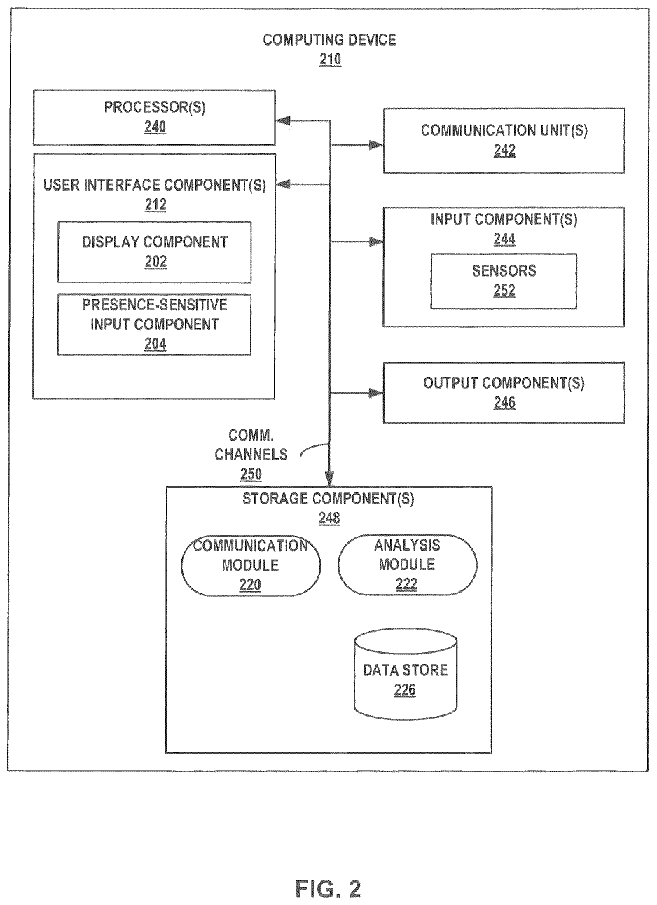

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and data store 226.

One or more processors 240 may implement functionality and/or execute instructions associated with computing device 210 to create a virtual yield map. That is, processors 240 may implement functionality and/or execute instructions associated with computing device 210 to gather information and apply the information to known actual yields to create virtual yield maps.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to gather information and create virtual yield maps.

Communication module 220 may execute locally (e.g., at processors 240) to provide functions associated with gathering data from a number of external sensors and controlling some of those external sensors to capture that data. In some examples, communication module 220 may act as an interface to a remote service accessible to computing device 210. For example, communication module 220 may be an interface or application programming interface (API) to a remote server that gathers data from a number of external sensors and controls some of those external sensors to capture that data.

In some examples, analysis module 222 may execute locally (e.g., at processors 240) to provide functions associated with processing the gathered information and creating a virtual yield map from that information. In some examples, analysis module 222 may act as an interface to a remote service accessible to computing device 210. For example, analysis module 222 may be an interface or application programming interface (API) to a remote server that processes the gathered information and creates a virtual yield map from that information.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 220 may collect one or more images from one or more satellites, the one or more images capturing at least a crop-containing plot. In some instances, in collecting the one or more images from the one or more satellites, communication module 220 may controlling, by the one or more processors, the one or more satellites to capture the one or more images.

Communication module 220 may collect topography information for the crop-containing plot from one or more topographical sensors. In some instances, in collecting the topography information from the one or more topographical sensors, communication module 220 may control the one or more topographical sensors to capture the topography information. In some instances, the topography information comprises any one or more of one or more satellite images, one or more LiDAR images, GPS information, and a map generated from the GPS information.

Communication module 220 may collect weather-related data for an area including the crop-containing plot, which may be publicly available data. In some instances, the weather-related data comprises any one or more of average temperature information, high temperature information, low temperature information, growing degree days, moisture information, precipitation information, amount of sunshine, and intensity of light.

Analysis module 222 may create, based at least in part on information associated with the one or more images, a spectral index map. In some instances, analysis module 222 may determine one of a plurality of unique crop indices based on a type of crop grown in the crop-containing plot. Analysis module 222 may filter based on the determined unique crop indices and colors not associated with the type of crop grown in the crop-containing plot from the one or more images to create one or more filtered images. Analysis module 222 may extract the information used to create the spectral index map from the one or more filtered images. In some instances, the colors not associated with the type of crop include one or more of brown, red, or soil colors.

In some instances, the information associated with the one or more images comprises one or more of a normalized difference vegetation index (NDVI) or an excess green, which may be determined based on the determined unique crop index.

In some instances, each of the one or more images are captured at a different time. In such instances, analysis module 222 may compare each of the one or more images to determine an optimal image based on peak values of the information associated with the one or more images. Analysis module 222 may determine the information associated with the optimal image to create the spectral index map. In some such instances, analysis module 222 may further utilize the topography information and the weather-related data that includes the time at which the optimal image was captured.

In general, the spectral index map, in some instances, may include a distributed classification of a normalized number representing a normal distribution of a yield of crop in the crop-containing plot.

Analysis module 222 may generate pixelized information for the crop-containing plot, the pixelized information comprising a plurality of pixels representative of an equal portion of the crop-containing plot, and wherein the pixelized information further comprises a normalized value representative of crop yield for each respective pixel of the plurality of pixels based at least in part on the spectral index map, the topography information, and the weather-related data. In some instances, in generating the pixelized information, analysis module 222 may calculate an acreage proportion for each of the plurality of pixels based at least in part on the spectral index map, the topography information, and the weather-related data.

Analysis module 222 may create a virtual yield map from the pixelized information. In some instances, in creating the virtual yield map, analysis module 222 may apply the pixelized information to a known actual yield to generate the virtual yield map comprising a representation of an actual amount of crops in the particular area represented by each respective pixel of the plurality of pixels.

In some instances, communication module 220 may output, to a display component, the virtual yield map in a graphical user interface.

In some instances, the one or more images may be multi-date aerial or satellite imagery captured across a growing season. In such instances, analysis module 222 may process the multi-date imagery as a time series using a recurrent neural network comprising a long short-term memory (LSTM) architecture to estimate standardized phenological stages and to select an optimal image window during an early reproductive stage based on peak or stable values of the information associated with the multi-date imagery. Analysis module 222 may handle missing imagery dates caused by cloud cover by one or more of interpolation across time steps, explicit masking of missing dates, or using models configured to cope with irregular temporal sampling.

In some instances, analysis module 222 may perform semantic segmentation of the one or more images to classify pixels into classes comprising crop, weed, bare soil, and residue using a convolutional neural network with an encoder-decoder architecture trained on manually labeled data. Analysis module 222 may mask clouds, cloud shadows, haze, roads, buildings, and water bodies using automated algorithms comprising thresholding and machine learning classifiers and optionally manual inspection, prior to creating the spectral index map.

In some instances, analysis module 222 may generate a timing-based zone map by partitioning timing deviation vectors using one or more of threshold-based classification, k-means clustering, Gaussian mixture models, or hierarchical clustering to identify zones comprising early, catch-up, and delayed maturity trajectories. Analysis module 222 may apply the timing-based zone map as a correction weighting layer to adjust the spectral index map and the pixelized information before creating the virtual yield map.

In some instances, the information associated with the one or more images may include one or more vegetation or canopy indices selected from the group consisting of green normalized difference vegetation index (GNDVI), normalized difference red-edge index (NDRE), red-edge position (REIP), enhanced vegetation index (EVI), soil-adjusted vegetation index (SAVI), modified soil-adjusted vegetation index (MSAVI or MSAVI2), normalized difference water index (NDWI), normalized difference moisture index (NDMI), multi-band drought indices, thermal-based metrics, and canopy height or surface models. In such instances, the one or more images comprise spectral bands may include blue, green, red, near-infrared, red-edge, and shortwave infrared, and the topography information may include elevation, slope, aspect, and compound terrain indices including a topographic wetness index, and the weather-related data further comprises solar radiation, humidity, wind, evapotranspiration, and soil water storage.

In some instances, analysis module 222 may segment the crop-containing plot into analysis units comprising one or more of regular grid cells, management zones, or polygons defined by soil or electrical conductivity classes. In such instances, analysis module 222 may derive, for each acquisition time, a feature vector for each analysis unit. Analysis module 222 may also append, to each feature vector, time-varying environmental variables comprising daily temperature, cumulative growing degree days, and rainfall over recent windows, static covariates comprising soil properties, topography, and long-term management indicators, and ancillary datasets comprising one or more of planting date, seeding rate, row spacing and orientation, type and timing of tillage, fertilizer and manure applications including type, rate, timing, and placement, irrigation events, cover crop species and termination, traffic patterns, and crop protection measures.

The following is one example of a use case study that utilized the various techniques described herein. It should be known that this is merely one example study, and that different data, including different crops, different topography, different weather, and different locales may produce different data. The examples described below are merely one example of the values, but other values derived from the same techniques as described herein are intended to be conceived herein.

Yield map is of important tool in precision agriculture to make management zones map. This examples aims to remote sensing data specifically the application of Normalized Difference Vegetation Index (NDVI) maps to optimize yield distribution in corn and soybean fields in South Dakota. Sentinel-2 satellite imagery may provide NDVI data during the growing season. The analysis identified the early reproductive stage as the optimal period for employing NDVI maps to distribute yield. Applying the developed methodology in this study showed the correlation (r) between actual and distributed yield ranges from 0.52 to 0.88 with a mean of 0.73 and from 0.65 to 0.85 with a mean of 0.74 for corn and soybean, respectively. The strong correlations between actual and distributed yield maps show that NDVI-based methodologies can effectively estimate yield potential in precision agriculture, with implications for enhancing productivity and environmental sustainability.

Precision agriculture is a modern farming approach that utilizes electronic information systems and advanced technologies to collect, process, and analyze spatial and temporal data. By analyzing and interpreting information from precision agriculture techniques can create some real-time maps that show different levels of nutrients and irrigation requirements. Precision agriculture strategies effectively balance both agricultural production and environmental goals, by optimizing agricultural inputs impact. Generally, optimizing inputs ensures that plants receive the right amount of nutrients and water, resulting in better growth and higher crop yields. By using precision agriculture technologies, farmers can apply inputs only where they are needed. The reason for different requirements in the field is related to the variability in soil quality, moisture, and nutrient levels. Identifying field variations not only increases yield but also reduces overall input consumption. The combined effect of increased crop yield and cost savings directly enhances profitability.

The yield monitoring system, aerial imagery, soil test results, Electrical Conductivity (EC) mapping, topography, and NRCS soil survey maps provide important information for identifying field variations and creating management zone map. The soil test results, EC mapping, topography, and NRCS soil survey map consider only some intrinsic factors affecting the capability of a field. This information cannot account for dynamic conditions, such as weather patterns and other environmental interactions. However, data-sources extracted from yield map (from yield monitoring system) capture all factors influencing agricultural productions. However, there is no yield monitoring system on many of the commonly used combines. For this reason, several studies tried to predict yield data by considering different environmental factors.

The environmental factors, such as extreme weather events, temperature, precipitation, soil type and moisture conditions, terrain, and others are parts of the basic dynamic of the vegetation and yield. In this way, soil properties and climate factors such as precipitation and temperature properties have significantly influenced the dynamic of vegetation and yield. The effect of temperature on vegetation, for instance, was higher than precipitation in certain geographies. By contrast, it was found that precipitation has a stronger effect than temperature on vegetation. Therefore, these inconsistencies in yield predictions highlight the challenges in accurately predicting yield across different environmental contexts.

Arial imagery, like Satellite images, provides a comprehensive method to assess various factors influencing plant growth and yield. By analyzing spectral indices derived from these images, especially normalized difference vegetation index (NDVI), it is possible to detect variations in growth patterns across a field. The NDVI extracted from remote sensing data is an important data-source for monitoring growth statues of vegetation cover due to its continuous time series, high spatial resolution, and scale. There are several reasons for the widely used NDVI to describe vegetation coverage. One of the main advantages of employing NDVI is that it is explicitly sensitive to green vegetation and low vegetation coverage of regional scale. This allows us to monitor and analyze the spatiotemporal variation mechanisms of vegetation for a better understanding of the agricultural land characteristics especially in arid, semi-arid, and sub-humid areas. Hence, the objectives of this research were i) to investigate the NDVI maps during growing season and ii) to analyze and determine the suitable time for distributing yield using remote sensing data and then creating management zones map.

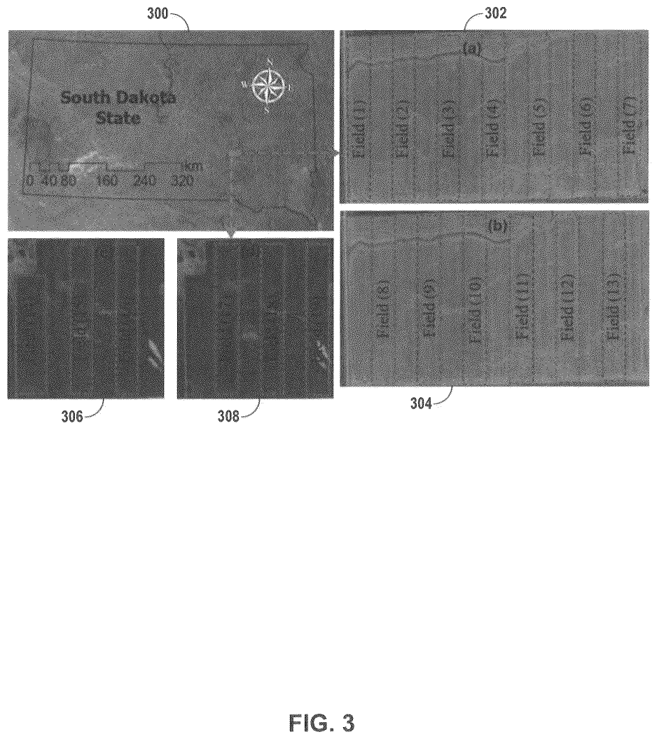

FIG. 3 includes representations of studied fields on the southern parts of South Dakota State 300, field set A 302 (fields 1-7 (a)), field set B 304 (fields 8-13 (b)), field set C 306 (fields 14-16 (c)), and field set D 308 (fields 17-19 (d)), in accordance with one or more techniques described herein. The study areas were conducted in the southern part of South Dakota State, USA (FIG. 1). The studied fields were in Aurora County the field 1 to 13 (120 ha) with 43°53′49.87″ N and 98°28′58.77″ W and the field 14 to 19 (60 ha) with 43°52′54.6″ N and 98° 38′8.52″ W. In the present study, two main fields were selected for the purpose of making a yield map. For investing more fields, each field was divided into different sections, approximately 20 acres each. To maintain a reliable margin of confidence and overlapping problems, these sections were alternately selected for extracting. By focusing on individual sections separately, the isolated and accuracy of yield measurements were ensured.

The Sentinel-2 satellite imagery may be applied as the primary data source. The cloud-free Sentinel-2 MSI (MultiSpectral Instrument) Level-2 images captured during the crop growing seasons are especially close to the starting date of the reproductive stages. After that, the necessary preprocessing steps, including geometric and radiometric corrections performed on these images, may be performed to ensure the accuracy and comparability of the data over the different years. The Normalized Difference Vegetation Index (NDVI) may be calculated using the following formula:

$$( {ρ}_{NIR} - {ρ}_{R} ) / ( {ρ}_{NIR} + {ρ}_{R} )$$

Where ρ_{NIR} is the Near-Infrared band and ρ_{R} is the Red band. NDVI is a key indicator of vegetation health and greenness, with values ranging from −1 to +1, where higher values indicate denser and healthier vegetation.

In this methodology, the NDVI map and the total yield of the field are used to generate historical yield maps. The following equations are applied to have historical yield maps:

### i) Normalization of NDVI (NNDVI):

$$NNDVI = [ ( Mean - 2.5 \times SD ) + \\ ( \frac{NDVI - Min}{Max - Min} ) ] * [ ( Mean + 2.5 * SD ) - Mean - 2.5 * SD ) ] + ( Mean - 2.5 * SD )$$

In this equation, the NDVI values are normalized by using the minimum, maximum, mean, and standard deviation (SD) of NDVI values in the field.

### ii) Total Weighted NDVI (TWNDVI):

$$TWNDVI = NNDVI * ( Pixel size * Pixel size )$$

Where, the TWNDVI is calculated by multiplying each NNDVI value by the area of each pixel (pixel size squared).

iii) Historical Yield Map:

$$Yield = NNDVI * ( Pixel size * Pixel size ) * ( \frac{Total field Yield}{TWNDVI} )$$

Where NNDVI is normalized NDVI, SD shows standard deviation, and TWNDVI represents the total weighted NDVI.

In the final equation, the yield for each pixel is estimated by using the NNDVI value, the pixel area, and a scaling factor, which is the ratio of the total field yield to the TWNDVI.

The crop's phenological development is driven by the daily accumulation of heat units, which are calculated as follows:

$$GDD = \frac{{T}_{max} + {T}_{min}}{2} - {T}_{base}$$

Where GDD is the growth degree days, Tₘₐₓ, Tₘᵢₙ, and T_{base} are the maximum, minimum temperature and crop-specific base temperature in ° C. (no growth occurs at or below T_{base}).

A Heat Unit Index (HUI) is calculated as follows:

$${HUI}_{i} = \frac{{Σ}_{k = 1}^{i} {GDD}_{k}}{{PGDD}_{j}}$$

Where PGDDᵢ represents the total potential GDD needed for crop j to reach full maturity. The HUI is a measure used to monitor the developmental progress of a crop, from the initial planting stage to its physiological maturity. It ranges from zero, representing the moment of planting, to 1.0, signifying that the crop has reached full maturity. This index allows researchers and agronomists to quantify growth stages based on accumulated thermal energy, offering a precise way to predict and assess the crop's progression.

The water stress index (WSI) is calculated using the following equation:

$$WSI = \frac{{Σ}_{l = 1}^{nl} {u}_{l}}{{E}_{p}}$$

Where WSI ranges from zero to 1.0. A value closer to 1.0 indicates lower water stress, while a value closer to 0 indicates higher water stress. uₗ is the plant water use in the lth soil layer, measured in millimeters (mm). nl is the number of soil layers being considered, Eₚ is the evapotranspiration component (mm).

The temperature stress index (TSI) is calculated with the following equation:

$$TSI = sin ( \frac{π}{2} \frac{{T}_{a} - {T}_{b}}{{T}_{o} - {T}_{b}} )$$

Where the TSI ranges from zero to 1.0. A value closer to 1.0 indicates lower temperature stress, while a value closer to zero indicates higher temperature stress. Tₐ shows the average daily temperature for the crop (° C.). T₀ represents the optimum temperature for the crop (° C.).

In the current study, correlation analysis was used as a key statistical tool to evaluate the effectiveness and reliability of the methodology. Correlation analysis helped identify the strength and direction of relationships between actual and distributed yield maps.

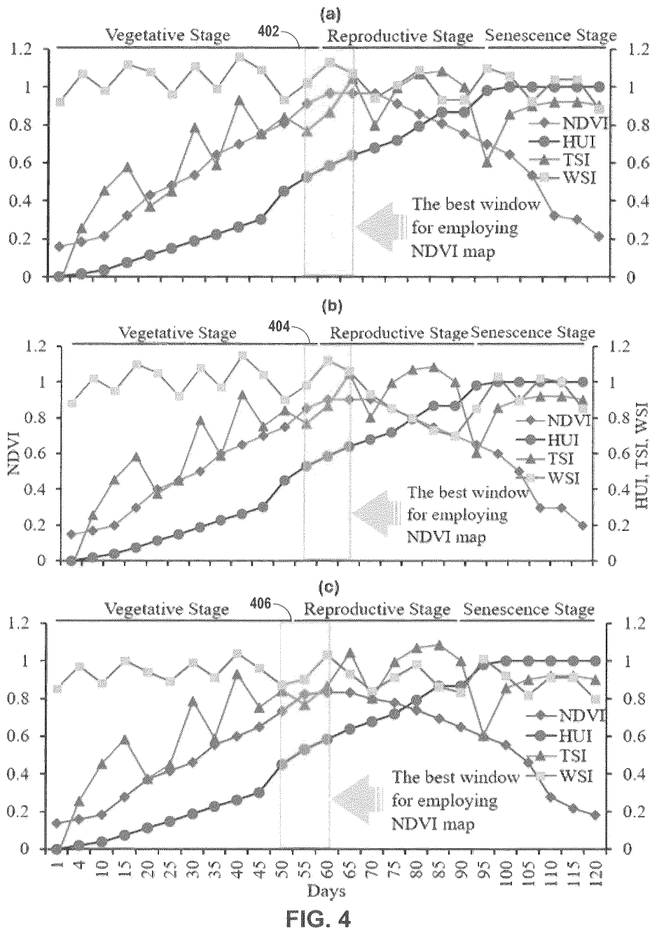

FIG. 4 is chart for determining, in one example, the best window of employing NDVI data to distribute yield map in clay soil graph 402, loam soil graph 404, and sandy soil graph 406, in accordance with one or more techniques described herein.

In the present study, an extensive analysis of NDVI values across the growing season was conducted to determine the optimal timing for yield distribution mapping in corn and soybean crops within a designated study area. FIG. 4 provides a detailed representation of NDVI trends alongside HUI, TSI, and WSI values in three soil textures such as clay, loam, and sandy. This analysis showed distinct growth stages including Vegetative, Reproductive, and Senescence.

In the Vegetative Stage (days 1 to 50), NDVI values show a steady increase as the crop canopy expands, reflecting growth in leaf area and high photosynthetic activity. This trend is observed across all soil textures, with NDVI values rising more gradually in clay soil (a of FIG. 4) compared to loam (b of FIG. 4) and sandy soils (c of FIG. 4). The increasing NDVI values in this stage associate with early crop development, as plants give energy toward leaf and stem growth, establishing a strong canopy. During this period, the HUI values increase slowly, indicating gradual health improvements as the plants grow.

As the plants transition into the Reproductive Stage, NDVI values peak, marking the stage of maximum canopy cover and photosynthetic efficiency. This stage is critical for yield formation, as reproductive development, such as flowering and grain filling, occurs. FIG. 4 shows that NDVI reaches its highest values between days 60 to 70 in clay and loam soils (a and b of FIG. 4) and between days 50 to 60 in sandy soil (c of FIG. 4). This slight variation in soil types reflects differences in soil moisture retention and nutrient availability, impacting the timing of peak vegetative health. During this peak NDVI period, the HUI values also reach their maximum, indicating optimal plant health and vigor. TSI and WSI values rise slightly, suggesting a mild increase in temperature and water-related stress; however, these indices remain within manageable limits. However, the Senescence Stage follows, where NDVI values gradually decline across all soil types as the crop matures and the canopy begins to senesce. Correspondingly, WSI values increase, indicating higher water stress in sandy soils, likely due to lower water-holding capacity.

The light green area within the Reproductive Stage in FIG. 4 identifies the best window for employing the NDVI map for yield distribution. This period, ranges days 55 to 70 depending on soil texture, represents the optimal timing for NDVI-based yield mapping as it provides the most accurate reflection of crop health, biomass potential, and yield prediction capability. In clay and loam soils, the best timing is between days 60 to 70, while in sandy soil, this window shifts slightly earlier to days 55 to 60. It is because of the faster progression of plant maturity under potentially drier conditions.

The historical yield maps included for fields 1 through 13 (as shown in FIG. 3), covering for soybean in 2019 and corn in 2020. Additionally, fields 14 through 19 had historical yield maps for corn in 2021. By considering different years and considered fields, the studied areas were 28 fields about 20 acres. The result of employing methodology for a sample field including corn and soybean are presented in FIGS. 3-5, respectively. In the presented sample field, the area and total yield for corn and soybean were 21.25 and 21.40 acres; 3428.51 and 1298.56 bushels, respectively. As can be seen from the figures, the trend of actual yield variation can be explained precisely by the methodology described herein. In detail, the distributed yield map, distributed using NDVI map, shows a higher potential to make yield map. High- and low-yield areas in the distributed map (shown in dark green) largely correspond with high- and low-yield areas in the actual yield map for both crop types, respectively. Overall, the trend for the studied crops including corn and soybean showed the NDVI map extracted from remote sensing data can be a useful tool for distributing yield map.

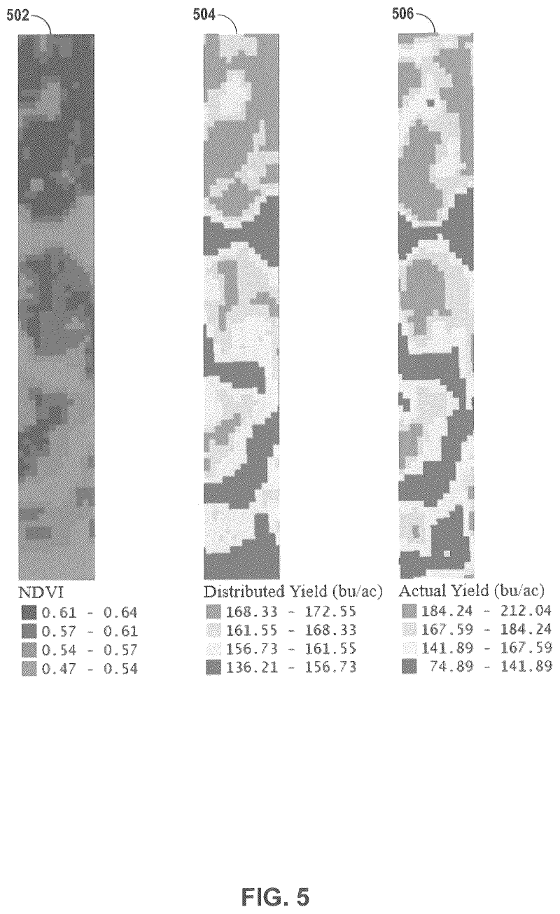

FIG. 5 are maps illustrating NDVI 502, distributed yield 504, and actual corn yield 506 maps for a sample field, in accordance with one or more techniques described herein. These graphs provide a visual comparison of the NDVI values 502, the distributed yield predictions 504, and the actual yield measurements 506 across the plot.

The NDVI 502 graph represents the spatial distribution of NDVI values across the crop-containing plot. The NDVI values are color-coded, with varying shades of green indicating different levels of vegetation health and density. Higher NDVI values correspond to healthier and denser vegetation, while lower values indicate less healthy or sparse vegetation.

The distributed yield 504 graph depicts the predicted yield distribution across the crop-containing plot in bushels per acre. The distributed yield is derived from the pixelized information generated by the system, which incorporates the spectral index map 102, topography information, and weather-related data. The yield values are represented using a color gradient, with each color corresponding to a specific range of yield values.

The actual yield 506 graph represents the measured yield distribution across the crop-containing plot in bushels per acre. Similar to the Distributed Yield 504 graph, the Actual Yield 506 graph uses a color gradient to indicate the yield values, allowing for a direct visual comparison between the predicted and actual yield distributions.

These graphs collectively demonstrate the correlation between NDVI values 502, predicted yield 504, and actual yield 506, providing insights into the accuracy and effectiveness of the system in estimating crop yield.

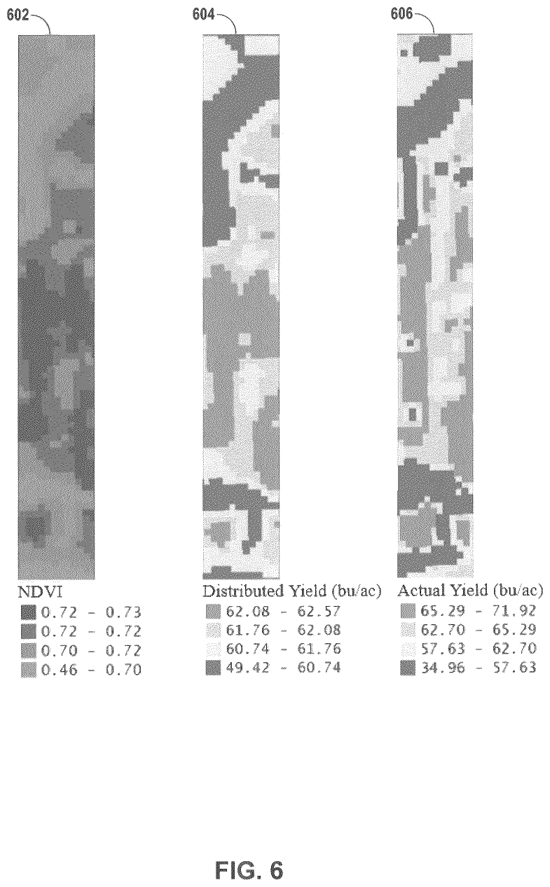

FIG. 6 are maps illustrating NDVI 602, distributed yield 604, and actual soybean yield 606 maps for a sample field, in accordance with one or more techniques described herein. The figure provides a comparative visualization of normalized difference vegetation index (NDVI) values, estimated yield distribution, and actual yield data, enabling an analysis of correlations and deviations between predicted and observed yield outcomes.

The NDVI 602 graph represents the normalized difference vegetation index values across the crop-containing plot. NDVI is a spectral index used to assess vegetation health and vigor by analyzing the reflectance of specific wavelengths. The NDVI 602 map categorizes the plot into varying levels of vegetation health, with higher values indicating healthier vegetation and lower values suggesting potential stress or reduced growth. This component serves as a foundational input for yield estimation processes.

The distributed yield 604 graph depicts the estimated yield distribution across the crop-containing plot, expressed in bushels per acre (bu/ac). This map is generated based on the spectral index map 102, topography information, and weather-related data, as described in the disclosed system. The Distributed Yield 604 map provides a pixelized representation of predicted yield values, enabling the identification of areas with varying productivity levels and facilitating targeted agricultural interventions.

The actual yield 606 graph represents the observed yield data collected from the crop-containing plot, also expressed in bushels per acre (bu/ac). This map provides a ground-truth comparison to the Distributed Yield 604 map, highlighting discrepancies between predicted and actual yield values. The Actual Yield 606 map plays a significant role in validating the accuracy of the yield estimation methodology and refining the predictive models used in the described system.

The figure collectively demonstrates the interplay between NDVI 602 values, estimated yield distribution 604, and actual yield data 606, offering insights into the effectiveness of the spectral index-based yield prediction approach. This highlights the significance of integrating spectral, topographical, and weather-related data to achieve accurate and actionable yield estimations.

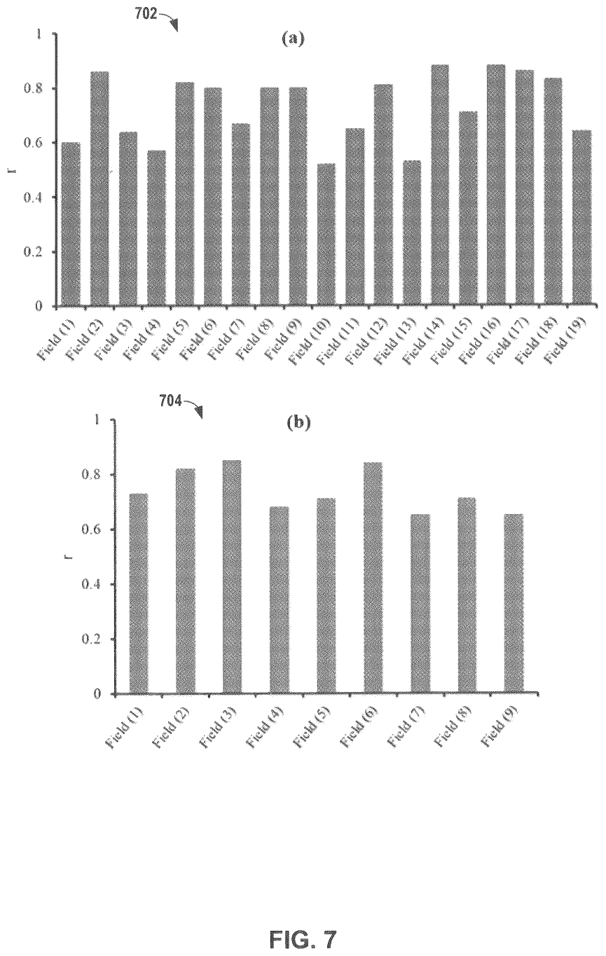

FIG. 7 is a pair of charts illustrating results of evaluating developed methodology; r (correlation coefficient) for corn 702 and soybean 704 fields, in accordance with one or more techniques described herein. FIG. 7 displays the correlation coefficient (r) values between actual and distributed yield for evaluating the developed methodology applied to corn (a) and soybean (b) in various fields. In (a) of FIG. 7, representing corn fields, r values range from 0.52 to 0.88, indicating variability among fields. The highest rrr value (0.88) was observed in Fields 14 and 16, while the lowest rrr value (0.52) occurred in Field 10. In this way, (b) of FIG. 7 shows the r values for soybean fields, ranging from 0.65 to 0.85, with the highest r value in Field 3 and the lowest in Field 9. Despite these generally strong correlations, lower r values indicate discrepancies in the methodology, as actual yield is sometimes lower than distributed yield predictions in certain areas. These differences could be attributed to factors such as variable water availability and sudden environmental stresses, which the methodology may not fully accounted.

The results of this study showed the effectiveness of using remote sensing data specifically NDVI data, particularly during the early reproductive stage, to create accurate yield maps for corn and soybean fields. The developed methodology allows for precise management of field variability, improving resource portion and optimizing crop yields. By identifying high and low-yield areas with NDVI, farmers can adopt precision strategies that optimize inputs and enhance profitability. The methodology presented in this study shows that there is no need to have a yield monitor system for identifying field variations. Overall, the study demonstrates that NDVI-based yield mapping is a valuable tool for precision agriculture, supporting both agricultural productivity and sustainability.

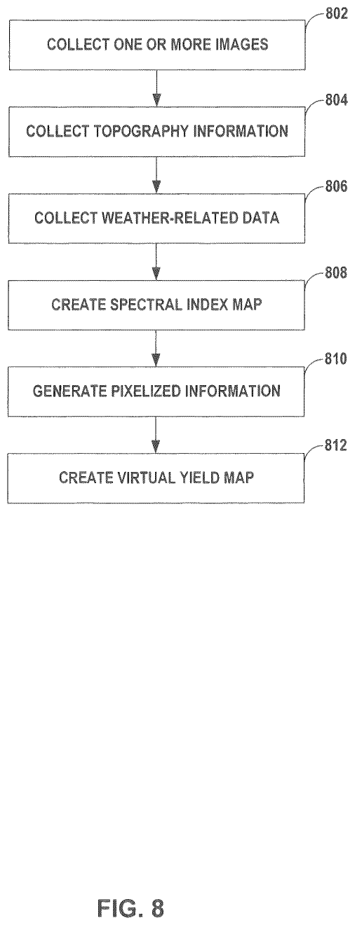

FIG. 8 is a flow diagram illustrating an example method for calculating a virtual yield map, in accordance with one or more techniques described herein. The techniques of FIG. 8 may be performed by one or more processors of a computing device, such as computing device 110 of FIG. 1 and/or computing device 210 illustrated in FIG. 2. For purposes of illustration only, the techniques of FIG. 8 are described within the context of computing device 210 of FIG. 2, although computing devices having configurations different than that of computing device 210 may perform the techniques of FIG. 8.

In accordance with the techniques of this disclosure, communication module 220 collects one or more images from one or more satellites, the one or more images capturing at least a crop-containing plot (802). Communication module 220 collects topography information for the crop-containing plot from one or more topographical sensors (804). Communication module 220 collects weather-related data for an area including the crop-containing plot (806). Analysis module 222 creates, based at least in part on information associated with the one or more images, a spectral index map (808). Analysis module 222 generates pixelized information for the crop-containing plot, the pixelized information comprising a plurality of pixels representative of an equal portion of the crop-containing plot, and wherein the pixelized information further comprises a normalized value representative of crop yield for each respective pixel of the plurality of pixels based at least in part on the spectral index map, the topography information, and the weather-related data (810). Analysis module 222 creates a virtual yield map from the pixelized information (812).
Example 1. A method comprising: (a) collecting, by one or more processors, one or more images from one or more satellites, the one or more images capturing at least a crop-containing plot; (b) collecting, by the one or more processors, topography information for the crop-containing plot from one or more topographical sensors; (c) collecting, by the one or more processors, weather-related data for an area including the crop-containing plot; (d) creating, by the one or more processors and based at least in part on information associated with the one or more images, a spectral index map; (e) generating, by the one or more processors, pixelized information for the crop-containing plot, the pixelized information comprising a plurality of pixels representative of an equal portion of the crop-containing plot, and wherein the pixelized information further comprises a normalized value representative of crop yield for each respective pixel of the plurality of pixels based at least in part on the spectral index map, the topography information, and the weather-related data; and (f) creating, by the one or more processors, a virtual yield map from the pixelized information.
Example 2. The method of Example 1, wherein collecting the one or more images from the one or more satellites comprises controlling, by the one or more processors, the one or more satellites to capture the one or more images.
Example 3. The method of one or more of Examples 1-2, wherein collecting the topography information from the one or more topographical sensors comprises controlling, by the one or more processors, the one or more topographical sensors to capture the topography information.
Example 4. The method of one or more of Examples 1-3, further comprising: (a) determining, by the one or more processors, one of a plurality of unique crop indices based on a type of crop grown in the crop-containing plot; (b) filtering, by the one or more processors, colors not associated with the type of crop grown in the crop-containing plot from the one or more images to create one or more filtered images; and (c) extracting, by the one or more processors, the information used to create the spectral index map from the one or more filtered images.
Example 5. The method of Example 4, wherein the colors not associated with the type of crop include one or more of brown, red, or soil colors.
Example 6. The method of any one or more of Examples 1-5, wherein the information associated with the one or more images comprises one or more of a normalized difference vegetation index (NDVI) or an excess green.
Example 7. The method of any one or more of Examples 1-6, wherein each of the one or more images are captured at a different time, and wherein the method further comprises: (a) comparing, by the one or more processors, each of the one or more images to determine an optimal image based on peak values of the information associated with the one or more images; and (b) determining, by the one or more processors, the information associated with the optimal image to create the spectral index map.
Example 8. The method of Example 7, further comprising: (a) utilizing, by the one or more processors, the topography information and the weather-related data that includes the time at which the optimal image was captured.
Example 9. The method of any one or more of Examples 1-8, wherein the topography information comprises any one or more of: (i) one or more satellite images, (ii) one or more LiDAR images, (iii) GPS information, and (iv) a map generated from the GPS information.
Example 10. The method of any one or more of Examples 1-9, wherein the weather-related data comprises any one or more of: (i) average temperature information, (ii) high temperature information, (iii) low temperature information, (iv) growing degree days, (v) moisture information, (vi) precipitation information, (vii) amount of sunshine, and (viii) intensity of light.
Example 11. The method of any one or more of Examples 1-10, wherein the spectral index map comprises a distributed classification of a normalized number representing a normal distribution of a yield of crop in the crop-containing plot.
Example 12. The method of any one or more of Examples 1-11, wherein generating the pixelized information further comprises: (a) calculating, by the one or more processors, an acreage proportion for each of the plurality of pixels based at least in part on the spectral index map, the topography information, and the weather-related data.
Example 13. The method of any one or more of Examples 1-12, wherein creating the virtual yield map further comprises: (a) applying, by the one or more processors, the pixelized information to a known actual yield to generate the virtual yield map comprising a representation of an actual amount of crops in the particular area represented by each respective pixel of the plurality of pixels.
Example 14. The method of any one or more of Examples 1-13, further comprising: (a) outputting, by the one or more processors and to a display component, the virtual yield map in a graphical user interface.
Example 15. The method of any one or more of Examples 1-14, wherein the one or more images comprise multi-date aerial or satellite imagery captured across a growing season, and wherein the method further comprises: (a) processing, by the one or more processors, the multi-date imagery as a time series using a recurrent neural network comprising a long short-term memory (LSTM) architecture to estimate standardized phenological stages and to select an optimal image window during an early reproductive stage based on peak or stable values of the information associated with the multi-date imagery; and (b) handling, by the one or more processors, missing imagery dates caused by cloud cover by one or more of interpolation across time steps, explicit masking of missing dates, or using models configured to cope with irregular temporal sampling.
Example 16. The method of any one or more of Examples 1-15, further comprising: (a) performing, by the one or more processors, semantic segmentation of the one or more images to classify pixels into classes comprising crop, weed, bare soil, and residue using a convolutional neural network with an encoder-decoder architecture trained on manually labeled data; and (b) masking, by the one or more processors, clouds, cloud shadows, haze, roads, buildings, and water bodies using automated algorithms comprising thresholding and machine learning classifiers and optionally manual inspection, prior to creating the spectral index map.
Example 17. The method of any one or more of Examples 1-16, further comprising: (a) generating, by the one or more processors, a timing-based zone map by partitioning timing deviation vectors using one or more of threshold-based classification, k-means clustering, Gaussian mixture models, or hierarchical clustering to identify zones comprising early, catch-up, and delayed maturity trajectories; and (b) applying, by the one or more processors, the timing-based zone map as a correction weighting layer to adjust the spectral index map and the pixelized information before creating the virtual yield map.
Example 18. The method of any one or more of Examples 1-17, wherein the information associated with the one or more images comprises one or more vegetation or canopy indices selected from the group consisting of green normalized difference vegetation index (GNDVI), normalized difference red-edge index (NDRE), red-edge position (REIP), enhanced vegetation index (EVI), soil-adjusted vegetation index (SAVI), modified soil-adjusted vegetation index (MSAVI or MSAVI2), normalized difference water index (NDWI), normalized difference moisture index (NDMI), multi-band drought indices, thermal-based metrics, and canopy height or surface models, wherein the one or more images comprise spectral bands including blue, green, red, near-infrared, red-edge, and shortwave infrared, and wherein the topography information further comprises elevation, slope, aspect, and compound terrain indices including a topographic wetness index, and the weather-related data further comprises solar radiation, humidity, wind, evapotranspiration, and soil water storage.
Example 19. The method of any one or more of Examples 1-18, further comprising: (a) segmenting, by the one or more processors, the crop-containing plot into analysis units comprising one or more of regular grid cells, management zones, or polygons defined by soil or electrical conductivity classes; (b) deriving, by the one or more processors, and for each acquisition time, a feature vector for each analysis unit; and (c) appending, by the one or more processors, and to each feature vector, time-varying environmental variables comprising daily temperature, cumulative growing degree days, and rainfall over recent windows, static covariates comprising soil properties, topography, and long-term management indicators, and ancillary datasets comprising one or more of planting date, seeding rate, row spacing and orientation, type and timing of tillage, fertilizer and manure applications including type, rate, timing, and placement, irrigation events, cover crop species and termination, traffic patterns, and crop protection measures.
Example 20. A method for performing any of the techniques of any combination of Examples 1-19.
Example 21. A device configured to perform any of the methods of any combination of Examples 1-19.
Example 22. An apparatus comprising means for performing any of the method of any combination of Examples 1-19.
Example 23. A non-transitory computer-readable storage medium having stored thereon instructions that, when executed, cause one or more processors of a computing device to perform the method of any combination of Examples 1-19.
Example 24. A system comprising one or more computing devices configured to perform a method of any combination of Examples 1-19.
Example 25. Any of the techniques described herein.

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAS), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount-including any integer-between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 43% This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

What is claimed is:

1. A method comprising:
(a) collecting, by one or more processors, one or more images from one or more satellites, the one or more images capturing at least a crop-containing plot;
(b) collecting, by the one or more processors, topography information for the crop-containing plot from one or more topographical sensors;
(c) collecting, by the one or more processors, weather-related data for an area including the crop-containing plot;
(d) creating, by the one or more processors and based at least in part on information associated with the one or more images, a spectral index map;
(e) generating, by the one or more processors, pixelized information for the crop-containing plot, the pixelized information comprising a plurality of pixels representative of an equal portion of the crop-containing plot, and wherein the pixelized information further comprises a normalized value representative of crop yield for each respective pixel of the plurality of pixels based at least in part on the spectral index map, the topography information, and the weather-related data; and
(f) creating, by the one or more processors, a virtual yield map from the pixelized information.

2. The method of claim 1, wherein collecting the one or more images from the one or more satellites comprises controlling, by the one or more processors, the one or more satellites to capture the one or more images.

3. The method of claim 1, wherein collecting the topography information from the one or more topographical sensors comprises controlling, by the one or more processors, the one or more topographical sensors to capture the topography information.

4. The method of claim 1, further comprising:
(a) determining, by the one or more processors, one of a plurality of unique crop indices based on a type of crop grown in the crop-containing plot;
(b) filtering, by the one or more processors, colors not associated with the type of crop grown in the crop-containing plot from the one or more images to create one or more filtered images; and
(c) extracting, by the one or more processors, the information used to create the spectral index map from the one or more filtered images.

5. The method of claim 4, wherein the colors not associated with the type of crop include one or more of brown, red, or soil colors.

6. The method of claim 1, wherein the information associated with the one or more images comprises one or more of a normalized difference vegetation index (NDVI) or an excess green.

7. The method of claim 1, wherein each of the one or more images are captured at a different time, and wherein the method further comprises:
(a) comparing, by the one or more processors, each of the one or more images to determine an optimal image based on peak values of the information associated with the one or more images; and
(b) determining, by the one or more processors, the information associated with the optimal image to create the spectral index map.

8. The method of claim 7, further comprising:
(a) utilizing, by the one or more processors, the topography information and the weather-related data that includes the time at which the optimal image was captured.

9. The method of claim 1, wherein the topography information comprises any one or more of:
(i) one or more satellite images,
(ii) one or more LiDAR images,
(iii) GPS information, and
(iv) a map generated from the GPS information.

10. The method of claim 1, wherein the weather-related data comprises any one or more of:
(i) average temperature information,
(ii) high temperature information,
(iii) low temperature information,
(iv) growing degree days,
(v) moisture information,
(vi) precipitation information,
(vii) amount of sunshine, and
(viii) intensity of light.

11. The method of claim 1, wherein the spectral index map comprises a distributed classification of a normalized number representing a normal distribution of a yield of crop in the crop-containing plot.

12. The method of claim 1, wherein generating the pixelized information further comprises:
(a) calculating, by the one or more processors, an acreage proportion for each of the plurality of pixels based at least in part on the spectral index map, the topography information, and the weather-related data.

13. The method of claim 1, wherein creating the virtual yield map further comprises:
(a) applying, by the one or more processors, the pixelized information to a known actual yield to generate the virtual yield map comprising a representation of an actual amount of crops in the particular area represented by each respective pixel of the plurality of pixels.

14. The method of claim 1, further comprising:
(a) outputting, by the one or more processors and to a display component, the virtual yield map in a graphical user interface.

15. The method of claim 1, wherein the one or more images comprise multi-date aerial or satellite imagery captured across a growing season, and wherein the method further comprises:
(a) processing, by the one or more processors, the multi-date imagery as a time series using a recurrent neural network comprising a long short-term memory (LSTM) architecture to estimate standardized phenological stages and to select an optimal image window during an early reproductive stage based on peak or stable values of the information associated with the multi-date imagery; and
(b) handling, by the one or more processors, missing imagery dates caused by cloud cover by one or more of interpolation across time steps, explicit masking of missing dates, or using models configured to cope with irregular temporal sampling.

16. The method of claim 1, further comprising:
(a) performing, by the one or more processors, semantic segmentation of the one or more images to classify pixels into classes comprising crop, weed, bare soil, and residue using a convolutional neural network with an encoder-decoder architecture trained on manually labeled data; and
(b) masking, by the one or more processors, clouds, cloud shadows, haze, roads, buildings, and water bodies using automated algorithms comprising thresholding and machine learning classifiers and optionally manual inspection, prior to creating the spectral index map.

17. The method of claim 1, further comprising:
(a) generating, by the one or more processors, a timing-based zone map by partitioning timing deviation vectors using one or more of threshold-based classification, k-means clustering, Gaussian mixture models, or hierarchical clustering to identify zones comprising early, catch-up, and delayed maturity trajectories; and
(b) applying, by the one or more processors, the timing-based zone map as a correction weighting layer to adjust the spectral index map and the pixelized information before creating the virtual yield map.

18. The method of claim 1,
wherein the information associated with the one or more images comprises one or more vegetation or canopy indices selected from the group consisting of green normalized difference vegetation index (GNDVI), normalized difference red-edge index (NDRE), red-edge position (REIP), enhanced vegetation index (EVI), soil-adjusted vegetation index (SAVI), modified soil-adjusted vegetation index (MSAVI or MSAVI2), normalized difference water index (NDWI), normalized difference moisture index (NDMI), multi-band drought indices, thermal-based metrics, and canopy height or surface models,
wherein the one or more images comprise spectral bands including blue, green, red, near-infrared, red-edge, and shortwave infrared, and
wherein the topography information further comprises elevation, slope, aspect, and compound terrain indices including a topographic wetness index, and the weather-related data further comprises solar radiation, humidity, wind, evapotranspiration, and soil water storage.

19. The method of claim 1, further comprising:
(a) segmenting, by the one or more processors, the crop-containing plot into analysis units comprising one or more of regular grid cells, management zones, or polygons defined by soil or electrical conductivity classes;
(b) deriving, by the one or more processors, and for each acquisition time, a feature vector for each analysis unit; and
(c) appending, by the one or more processors, and to each feature vector, time-varying environmental variables comprising daily temperature, cumulative growing degree days, and rainfall over recent windows, static covariates comprising soil properties, topography, and long-term management indicators, and ancillary datasets comprising one or more of planting date, seeding rate, row spacing and orientation, type and timing of tillage, fertilizer and manure applications including type, rate, timing, and placement, irrigation events, cover crop species and termination, traffic patterns, and crop protection measures.

20. A non-transitory computer-readable storage medium having stored thereon instructions that, when executed, cause one or more processors of a computing device to:
(a) collect one or more images from one or more satellites, the one or more images capturing at least a crop-containing plot;
(b) collect topography information for the crop-containing plot from one or more topographical sensors;
(c) collect weather-related data for an area including the crop-containing plot;
(d) create, based at least in part on information associated with the one or more images, a spectral index map;
(e) generate pixelized information for the crop-containing plot, the pixelized information comprising a plurality of pixels representative of an equal portion of the crop-containing plot, and wherein the pixelized information further comprises a normalized value representative of crop yield for each respective pixel of the plurality of pixels based at least in part on the spectral index map, the topography information, and the weather-related data; and
(f) create a virtual yield map from the pixelized information.
